(19) United States
(12) Patent Application Publication
(10) Pub. No.: US 2021/0012399 A1
(43) Pub. Date: Jan. 14, 2021

(54) PATH DETERMINATION DEVICE, PATH DETERMINATION METHOD, AND STORAGE MEDIUM

(71) Applicant: NEC CORPORATION, Tokyo (JP)

(72) Inventor: Manao MACHIDA, Tokyo (JP)

(73) Assignee: NEC CORPORATION, Tokyo (JP)

(21) Appl. No.: 17/041,846

(22) PCT Filed: Mar. 28, 2018
(86) PCT No.: PCT/JP2018/012891

§ 371 Date: Sep. 25, 2020

(51) Int. Cl. G06Q 30/02; G01C 21/34

(52) U.S. Cl. CPC G06Q 30/0284; G01C 21/3415; G01C 21/3461

(57) ABSTRACT

A path determination device calculates a cost for a plurality of mobile bodies to travel, based on a time loss, the time loss indicating a temporal loss that arises when at least one of the plurality of mobile bodies takes a detour around another one of the mobile bodies.

### TECHNICAL FIELD

The present invention relates to a path determination device, a path determination method, and a storage medium.

### BACKGROUND ART

Patent Document 1 and Non-Patent Document 1 disclose an example of a method for determining paths of a plurality of mobile bodies. The method disclosed in Patent Document 1 is a method of determining a path on the basis of priority of a mobile body, using a potential method, which is a kind of path planning method. This path determination on the basis of priority is performed particularly when detecting or predicting a conflict between mobile bodies in order to avoid that conflict. In the potential method, when a reaction force is assumed to be present between objects including a mobile body, a path of the mobile body is determined by calculating a track of the mobile body in the case of receiving the reaction force. At this time, a force acts as a reaction force in a direction away from an object with which the mobile body may possibly conflict, so that the path of the mobile body avoids the obstacle. In determining a path to avoid conflict between mobile bodies, a weak reaction force is set for a high-priority mobile body and a strong reaction force is set for a low-priority mobile body, and thereby a path having less track correction made therein is determined for the high-priority mobile body, which only receives a weak reaction force, and a path having significant track correction made therein is determined for the low-priority mobile body, which receives a strong reaction force.

The method disclosed in Non-Patent Document 1 is a method of determining a path, using a combinatorial auction. In this method, there is a role of an auctioneer for determining a route and calculating a payment price, and the auctioneer causes each mobile body to self-report a path required thereby and an amount of money the mobile body is able to pay in order to obtain the path. Then, based on the self-report, the auctioneer determines a path on which no conflict will occur and which yields the largest total reported amount of money, among a plurality of mobile body paths on which at most one path exists for each mobile body. Then, the auctioneer charges each mobile body, as a payment price, the difference between the maximum value of the sum of money in the case of path planning that excludes that mobile body, and the sum of money of the actually determined path plan while excluding that mobile body.

### PRIOR ART DOCUMENTS

### Patent Documents

[Patent Document 1] Japanese Unexamined Patent Application, First Publication No. 2008-242859

### Non-Patent Documents

[Non-Patent Document 1] Ofra Amir, Guni Sharon, and Roni Stern. “Multi-agent pathfinding as a combinatorial auction”, In AAAI, 2015

### SUMMARY OF THE INVENTION

### Problem to be Solved by the Invention

Even with such a method as disclosed in Patent Document 1 and Non-Patent Document 1, an appropriate cost for a mobile body to travel can be calculated only by a limited path determination method, and also, the calculation is difficult. The method disclosed in Patent Document 1 is merely a mechanism for determining a path based on priority, and the method does not calculate an appropriate cost based on priority. In the method disclosed in Non-Patent Document 1, the auctioneer charges a payment price as the cost for a mobile body to travel. However, it only supports a path determination method that determines which of the paths reported from respective mobile bodies is to be approved. Moreover, this path determination method and payment price calculation are NP-hard problems and calculation therefor is often difficult.

In response, there is a demand for a method of calculating an appropriate cost for a mobile body to travel, with respect to an arbitrary path determination method.

The present invention provides a path determination device, a path determination method, and a storage medium capable of solving the above problems.

### Means for Solving the Problem

According to one example aspect of the present invention, a path determination device includes: a price calculation means for calculating a cost for a plurality of mobile bodies to travel, based on a time loss, the time loss indicating a temporal loss that arises when at least one of the plurality of mobile bodies takes a detour around another one of the mobile bodies.

According to one example aspect of the present invention, a path determination method is executed by a computer and include the steps of: calculating a cost for a plurality of mobile bodies to travel, based on a time loss, the time loss indicating a temporal loss that arises when at least one of the plurality of mobile bodies takes a detour around another one of the mobile bodies; and determining paths of the plurality of mobile bodies, based on the calculated cost.

According to one example aspect of the present invention, a storage medium stores a program which causes a computer to function as: a means for calculating a cost for a plurality of mobile bodies to travel, based on a time loss, the time loss indicating a temporal loss that arises when at least one of the plurality of mobile bodies takes a detour around another one of the mobile bodies.

### Effect of the Invention

According to the path determination device, the path determination method, and the storage medium mentioned above, it is possible to calculate an appropriate cost for a mobile body to travel.

### BRIEF DESCRIPTION OF THE DRAWINGS

FIG. 1 is a block diagram showing a configuration of a path determination system according to a first example embodiment.

FIG. 2 is a flowchart showing operations of the path determination system according to the first example embodiment.

FIG. 3 is a block diagram showing a configuration of a path determination system according to a second example embodiment.

FIG. 4 is a first diagram for describing an operation of the example 1.

FIG. 5 is a second diagram for describing the operation of the example 1.

FIG. 6 is a third diagram for describing the operation of the example 1.

FIG. 7 is a fourth diagram for describing the operation of the example 1.

FIG. 8 is a diagram for describing the example 2.

FIG. 9 is a diagram showing a minimum configuration of a path determination device according to each example embodiment.

FIG. 10 is a diagram showing an example of a hardware configuration of the path determination device in each example embodiment.

### EXAMPLE EMBODIMENT

### First Example Embodiment

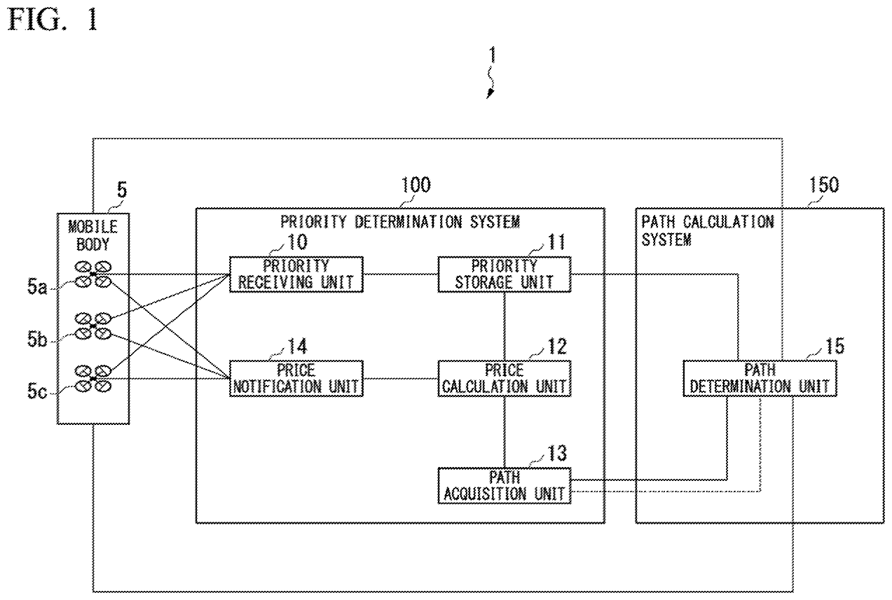

A first example embodiment of the present invention will be described in detail, with reference to FIG. 1 to FIG. 3.

### Description of Configuration

First, an overall configuration of the present example embodiment will be described, with reference to FIG. 1.

FIG. 1 is a block diagram showing a configuration of a path determination system according to the first example embodiment. A path determination system 1 according to the first example embodiment includes a priority determination system 100, a path calculation system 150, and mobile bodies 5a to 5c. The priority determination system 100 includes a priority receiving unit 10, a priority storage unit 11, a price calculation unit 12, a path acquisition unit 13, and a price notification unit 14. Note that the mobile bodies 5a to 5c may simply be referred to as mobile body 5 when there is no particular need for distinction therebetween and an arbitrary mobile body is the target mobile body. Moreover, the mobile body is not limited to a flying body such as a drone shown in FIG. 1 and so forth, and may be a mobile body which travels on land (such as a taxi, a truck, or a car) or may be a mobile body which travels on river or sea (such as a ship or a boat).

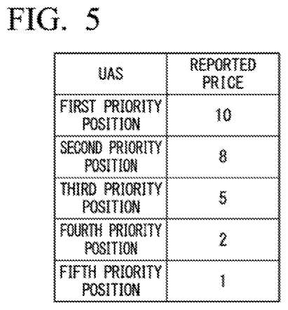

The priority receiving unit 10 receives, for example, priority information indicating a priority from each of the mobile bodies 5a to 5c, and stores the received priority information in the priority storage unit 11. The priority represents the degree to which the mobile body 5 is given priority in the path determination method. There is determined a path in which the higher the priority of the mobile body 5 is, the less the amount of time loss will be in the detour required to avoid a conflict with another mobile body (or a path which does not require a detour). A priority (will be described later with reference to FIG. 5) as shown in FIG. 5 as an example, may be assigned to each mobile body 5. The priority has a property such that the higher the priority of a given mobile body 5 is made while fixing the priority of other mobile bodies 5, an increase in the time loss of the path determined for that mobile body 5 is prevented.

The priority storage unit 11 stores priority information.

The price calculation unit 12 calculates a price on the basis of priority. The price represents the cost of traveling the determined path. For example, the mobile body 5 pays this cost to the priority determination system 100 or another mobile body 5. The price calculation unit 12 calculates the price, for example, based on the time loss that occurs when each mobile body 5 makes a detour.

The path acquisition unit 13 acquires information of the path generated by the path determination method according to the priority (including the case where the priority is different from the actual priority as described later).

The price notification unit 14 transmits information indicating the cost calculated by the price calculation unit 12 to, for example, the mobile bodies or a management device which manages the movement of each mobile body 5.

The path calculation system 150 acquires, from each of the mobile bodies 5a to 5c, path information used by each mobile body for traveling (applies for a traveling path), and when a conflict or the like is expected among several mobile bodies 5, calculates path information to avoid the conflict. The path calculation system 150 includes a path determination unit 15.

The path determination unit 15 determines a traveling path for each of the plurality of mobile bodies 5 on the basis of the priority determined by the priority determination system 100. The path determination unit 15 sends a notification of information of the determined path, to the priority determination system 100 and each of the mobile bodies 5a to 5c.

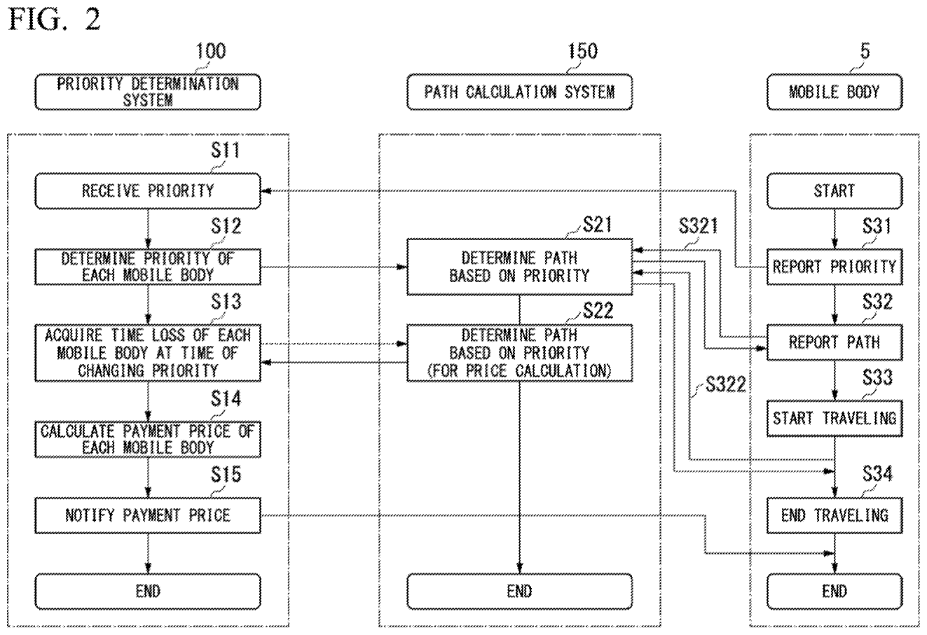

Next, an overall operation of the first example embodiment will be described with reference to FIG. 1 and FIG. 2.

FIG. 2 is a flowchart showing operations of the path determination system according to the first example embodiment.

For the sake of convenience of description, it is assumed that a priority is preliminarily determined for each mobile body 5a and so forth. Moreover, each of the mobile bodies 5a to 5c has information indicating priority (priority information) and path information indicating a traveling path (also referred to as “planned path”), and transmits the priority information to the priority determination system 100 (Step 31). Furthermore, each of the mobile bodies 5a to 5c transmits the path information to the path calculation system 150 before traveling (S321) or during traveling (S322) (Step S32).

Next, the priority determination system 100 receives the priority information transmitted by the priority receiving unit 10 (Step 11). Then, the priority determination system 100 stores the received priority information into the priority storage unit 11 (Step 12). Thereby, the priority of each mobile body 5 is determined. The priority determination system 100 transmits the priority information to the path calculation system 150.

Next, the path calculation system 150 performs a process of determining a path along which each mobile body 5 travels (hereunder, referred to as “path determination process”), on the basis of the received path information and the priority information (Step 21). The path determination process is performed before the mobile body 5 travels or while the mobile body 5 is traveling, for example. The path determination process performed while the mobile body 5 is traveling is a process of predicting an event (for example, a conflict) which can occur, for example, when several mobile bodies 5 pass through one given region at a given timing, and determining a path (for example, a detour path) to avoid the event. For example, in a case where two mobile bodies 5a and 5b would conflict with each other if they kept traveling straight, a detour path may be determined by finding a turning radius on the basis of the distance to the point of the predicted conflict for one of the mobile bodies 5a. The path determination process can be performed by any known method. The path determination process may be a process of calculating an amount of time (that is, a “waiting time”) for which a mobile body of a lower priority waits for a mobile body of a higher priority to have passed through the one given region, rather than a detour path calculation process such as the one described above. That is to say, in the path determination process, a plan for avoiding an event such as the one mentioned above is calculated. The path determination process is not limited to the above example. In the following description, for the sake of convenience of description, the operation of the path determination system will be described, using an example in which a process of calculating a detour path is performed in the path determination process.

The path calculation system 150 transmits, to the priority determination system 100, the path information received from each mobile body 5 and the path determined on the basis of priority. In the priority determination system 100, the path acquisition unit 13 compares these two paths and calculates, for each mobile body 5, a time loss in a case where the path determined based on priority is selected. For example, the time loss of the mobile body 5a can be calculated by “(the traveling time by the path determined based on the priority of the mobile body 5a (the amount of time required for arrival))−(the traveling time by the path information acquired from the mobile body 5a)”. In this manner, the path acquisition unit 13 acquires the time loss caused by the mobile body 5a or the like traveling on the detour path (Step 13). The process in which the path acquisition unit 13 acquires the time loss is performed, for example, in the case where it is determined that two mobile bodies are to pass through one given region at a given timing: while a mobile body 5 is traveling through the one given region; or after a mobile body has passed through the one given region.

Moreover, in the process shown in FIG. 2, the priority determination system 100 may transmit to the path calculation system 150, a plurality of priorities (provisional priority) for one mobile body 5. Furthermore, the priority determination system 100 may receive the path information created by the path calculation system 150 on the basis of the transmitted provisional priority (Step 22), to acquire the time loss caused by a detour. The path information and time loss based on the provisional priority will be described later in the example 1. The information received by the priority determination system 100 is not limited to the above example, and may be, for example: information indicating a time loss itself according to priority; information indicating a process (a path planning method) in the path determination device; or information representing the origin and the destination of each mobile body.

Next, the price calculation unit 12 calculates a traveling cost of the determined path on the basis of the time loss of each mobile body 5 caused as a result of traveling along the detour path (Step 14). The price calculation unit 12 calculates, by means of a predetermined function or the like, a larger cost as the time loss is larger, and a smaller cost as the time loss is smaller. Then, the price notification unit 14 transmits, for example, to each mobile body 5, information indicating the cost calculated by the price calculation unit 12 (Step 15). Transmission of the information indicating the cost may be performed after each mobile body 5 has finished traveling (after the arrival at the destination).

In the meantime, the mobile body 5a or the like receives the path based on the priority from the path calculation system 150, each starts traveling (Step 33), and ends traveling upon reaching its destination (Step S34).

The mobile body 5 which has received the information indicating the cost bears the cost. For example, the mobile body 5 cooperates with a payment system or the like included in the management device (for example, the priority determination system 100) which manages the traveling path or the like of each mobile body 5 and performs payment processing of money or the like corresponding to the received cost. Alternatively, the mobile body 5 may pay the received cost to another mobile body 5 which has detoured around the path therefor, through a predetermined payment system or the like. For example, when the mobile body 5a causes the mobile bodies 5b and 5c to detour, the cost paid to each mobile body 5b and 5c may be determined on the basis of the delays in arrival time and the priorities of the mobile bodies 5b and 5c. [0025]

According to the priority determination system 100 of the first example embodiment, it is possible to calculate an appropriate cost for a mobile body 5 to travel, with respect to an arbitrary path determination method. The reason for this is that the cost for the mobile bodies 5 to travel is determined on the basis of the time loss which occurs when a plurality of mobile bodies 5 travel (are attempting to travel, or have traveled) according to path determination.

Furthermore, according to the priority determination system 100 according to the first example embodiment, even in the case where the path calculation system 150 is not aware of the priority of each mobile body 5, the priority is determined based on the self-report of the mobile body 5, and real-time and efficient path determination can be performed for a plurality of self-interested mobile bodies, using the path determination method based on the priority. Here, the expression “self-interested” means that each mobile body 5 is traveling solely on the basis of its own interest (to arrive at its destination sooner).

In addition, since the mobile body 5 has only to report its own priority and a path which does not take into consideration conflict avoidance, the amount of time and effort required for self-reporting is reduced.

Moreover, according to the priority determination system 100 of the first example embodiment, as long as an appropriate cost is calculated on the basis of the time loss of the mobile body 5 itself, honest reporting can be encouraged by charging each mobile body 5 for the cost as a monetary payment, for example, to the priority determination system 100. This is because even if a false report is made as described later, the cost is charged only to match the amount of a profit (the amount of reduced time loss) to be gained from the false report. As a result, each mobile body 5 does not gain a profit from false reporting.

### Second Example Embodiment

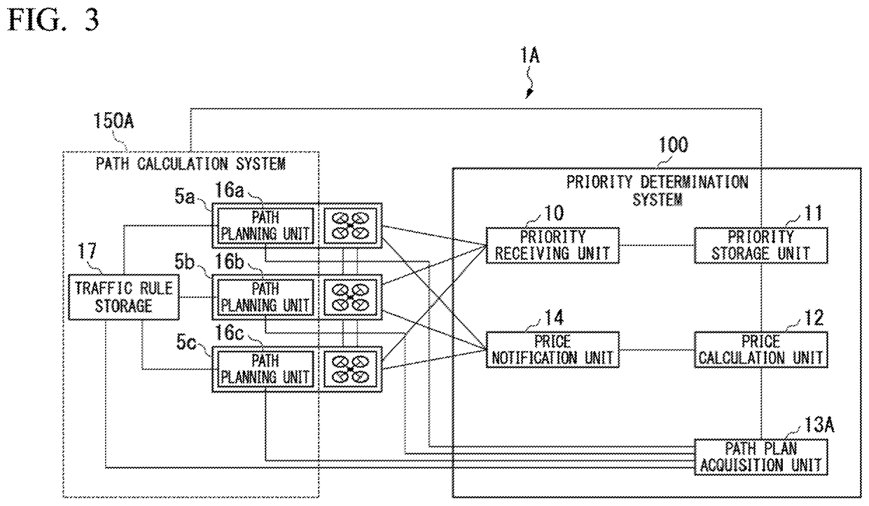

Next, a second example embodiment will be described in detail, with reference to FIG. 3.

FIG. 3 is a block diagram showing a configuration of a path determination system according to the second example embodiment. A path determination system 1A according to the second example embodiment includes a priority determination system 100A, a path calculation system 150A, and mobile bodies 5a to 5c. In the second example embodiment, the priority determination system 100A includes a path plan acquisition unit 13A instead of the path acquisition unit 13. Moreover, the path calculation system 150A is configured by including a path planning unit 16 and a traffic rule storage unit 17. Of these, the path planning unit 16 is mounted on the mobile body 5. For example, the mobile body 5a includes a path planning unit 16a, the mobile body 5b includes a path planning unit 16b, and the mobile body 5c includes a path planning unit 16c.

In the present example embodiment, each mobile body 5 determines path information by itself by using the path planning unit 16. Each mobile body 5 autonomously determines a path on the basis of traffic rules stored in the traffic rule storage unit 17 while interacting with other mobile bodies 5. Also, regarding a path in which priority has been changed for payment price calculation, each mobile body 5 exchanges information with each other to perform autonomous planning, and transmits a planned path to the path plan acquisition unit 13A on the basis of the priority.

The path plan acquisition unit 13A receives the path plan from each mobile body 5. Moreover, the path plan acquisition unit 13A acquires traffic rule information from the traffic rule storage unit 17, and determines whether the received path plan is appropriate according to the traffic rules and whether the path plan is feasible. If an inappropriate path (such as one which involves passing through a passage-prohibited section) has been sent, it sends a request to the mobile body 5 to re-send a path. Other configurations are similar to those of the first example embodiment.

An example of an operation of the second example embodiment will be described. The priority receiving unit 10 receives priority from each mobile body 5. Also, the path plan acquisition unit 13A receives a path plan from each mobile body 5. For example, in a case where the mobile body 5a and the mobile body 5b would conflict with each other and the mobile body 5a has a higher priority, the path planning unit 16b plans an avoidance path and transmits it to the path plan acquisition unit 13A. The path plan acquisition unit 13A determines whether the path plan is feasible and complies with the traffic rules. If the path plan does not meet these conditions, the path plan acquisition unit 13A requests the mobile body 5 which sent the traveling plan not meeting the conditions, to re-send a traveling plan. If the conditions are met, the path plan acquisition unit 13A notifies each mobile body 5 to that effect. Each mobile body 5 travels along the path planned by itself, avoiding a conflict. In addition, in parallel with traveling of each mobile body 5, in the priority determination system 100A, the price calculation unit 12 calculates a payment price as in the first example embodiment. The price notification unit 14 transmits the payment price for each mobile body 5 to the corresponding mobile body 5.

An example of the path calculation method in the second example embodiment will be described. Each mobile body 5 performs path planning for the case where the priority order of the mobile body 5 itself is increased by one, and transmits the previous position in the order thereof and the planned path to the mobile body in the position in the order next thereto (in the position in the order lower). The mobile body 5 which has received the path performs path planning for a mobile body in the position in an order higher than the received position in an order among the paths to be implemented (or having been implemented) and which does not conflict with the received path, and transmits a combination of the received position in the order and the path plan in which its own path plan is added to the received path plan to the mobile body in the position in the order next thereto. The above steps are repeated for all of the mobile bodies 5. Then, the mobile body 5 in the lowest position in priority order transmits the received path plan to the mobile body in the position in the order higher by one. The mobile body which has received the path plan from the mobile body in the lowest position in priority order raises its own priority order one by one from the lowest position to the actual position, and plans, for each of them, a path which does not conflict with the path plan in the order higher than the changed position among the received path plans, and transmits the path at each position in the order to the path plan acquisition unit 13A.

Hereunder, operations of the first and second example embodiments will be described, along with specific examples thereof.

### EXAMPLE 1

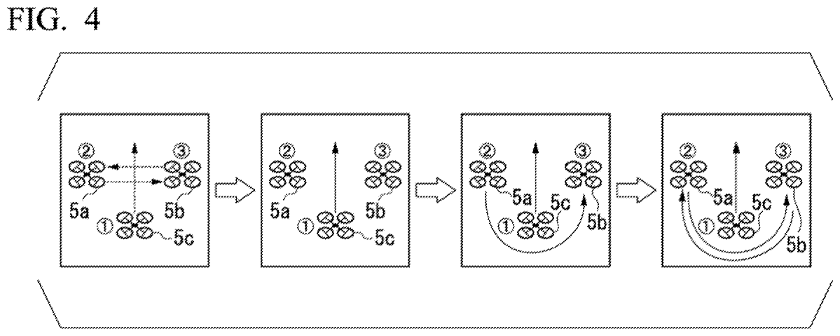

FIG. 4 to FIG. 7 are diagrams for describing the operation of the example 1, respectively.

In The example 1, there is considered a case where a prioritized CA* algorithm (Prioritized Cooperative A*) is specifically used as a path system planning algorithm. In this algorithm, the paths are determined in the order of priority from the highest priority. The path of each mobile body 5 is determined to be the shortest path which does not cause a conflict with the path of a mobile body 5 having a priority higher than that thereof

FIG. 4 shows an example of determining paths using the prioritized CA* algorithm. The number assigned to each mobile body 5 indicates the priority of that mobile body. That is to say, the first priority position is set to the mobile body 5c, the second priority position is set to the mobile body 5a, and the third priority position is set to the mobile body 5b. The mobile body 5c of the first priority position creates a path, and then the mobile body 5a of the second priority position creates a path which does not conflict with the path of the mobile body of the first priority. Lastly, the mobile body 5b of the third priority position creates a path which conflicts with neither the path of the mobile body 5c of the first priority position nor the mobile body 5a of the second priority position.

In the example 1, a description will be made, taking an example of path determination for aircraft, in which a control system generally controls paths therefor, or for unmanned aircraft such as UAS (Unmanned Aircraft Systems), which may possibly be managed under the control of a control system in the future. Comparing the configuration of the example 1 with the configuration shown in FIG. 1, the mobile bodies 5 in FIG. 1 correspond to aircraft or UAS in the example 1, and the priority determination system 100 and the path calculation system 150 correspond to a control system.

Operations of the UAS or the like and the control system in the example 1 will be specifically described, with reference to the flowchart of FIG. 2. Before traveling, each of the mobile bodies 5a to 5c reports, as a priority, the amount of money which can be paid in order to suppress time loss per unit time (Step 31). For example, if the unit time is one second, it is reported that up to 5 yen can be paid in order to suppress delay per second in arrival time. In other words, per unit time means that up to 5×5=25 yen can be paid in order to suppress delay of five seconds.

In the example 1, for example, a reported price is used as a priority as it is. FIG. 5 shows an example of priorities determined in Step 12. In the prioritized CA* algorithm, only the position in order is important for path determination, and for this reason, the positions in order are shown next to it. In the flowchart of FIG. 2, priority is reported before traveling, however, the example embodiment is not limited to this. For example, the priority reporting operation may include operations of, in addition: making reporting to set priority 0 unnecessary if there is no priority reporting; and/or re-reporting to change the priority while traveling.

In the path reporting of Step 32, each of the mobile bodies 5a to 5c reports only its own destination. The control system monitors the positions of the mobile bodies 5a to 5c in a real-time manner, and when several mobile bodies 5 come close to each other, performs path determination on the basis of priority in order to avoid a conflict (Step 21). First, the control system (path determination unit 15) confirms the priority of the mobile bodies 5 coming close to each other, and determines the path for the one having a higher priority (priority position), for example. This processing may be performed by the control system or may be performed by the mobile bodies 5 themselves as in the second example embodiment. When determining a path, the control system chooses a path which enables earliest arrival to the reported destination and which does not conflict with the path of a mobile body in an even higher priority order position, among the paths coming close thereto. In a situation where (directions of) destinations of the mobile bodies 5 are obvious based on the traveling directions thereof, the path reporting in Step 32 may be omitted and the control system may estimate the path of each mobile body 5.

Upon determining the paths, the control system notifies each mobile body 5 of the path thereof and instructs each mobile body 5 to travel according to the path. Upon receiving the instruction, the mobile bodies 5 change the path thereof according to the instruction and a conflict is avoided. Furthermore, the control system stores the situation at the time when the path determination was performed (stores which of the mobile bodies 5 changed the path thereof). Then, the control system determines, at an appropriate processing timing, a path in case the priority is different (a path on the basis of a provisional priority) in the situation where the path determination was performed (Step 22). The control system acquires the time loss at that time (Step 13).

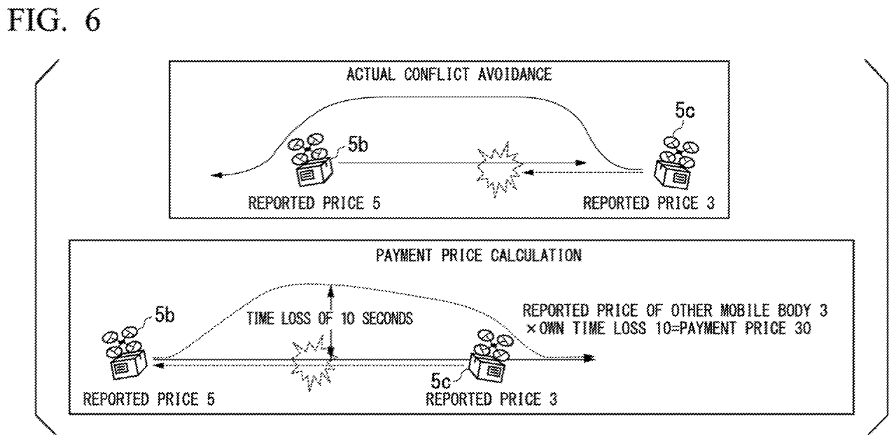

Next, payment price calculation in Step 14 will be described in detail. FIG. 6 exemplifies a payment price calculation in a case where a conflict is predicted between two mobile bodies 5b and 5c and either one of them changes the path thereof to avoid the conflict. Reported price per unit time (yen/second) =reported priority is “5” for the mobile body 5b and “3” for the mobile body 5c. Since the mobile body 5b having the higher priority keeps traveling along the path without change, in the actual path determination (conflict avoidance), the mobile body 5c having the priority 3 changes the path thereof for avoidance. On the other hand, in the calculation of the payment price of the mobile body 5b, which has reported the priority 5, there is determined a path (a path on the basis of a provisional priority) in the case where the priority of the mobile body 5b is assumed less than 3 and the mobile body 5b performs an avoidance maneuver (Step 22), and 10 seconds, which is the time loss in this case, is acquired (Step 13). The price reported by the other mobile body, 3 yen/second×own time loss of 10 seconds=30 yen, is the payment price (Step 14). On the other hand, the payment price for the mobile body 5c, which performed the avoidance maneuver, is 0 yen. When the payment price is generalized for two mobile bodies, the payment price for the mobile body of the higher priority is (payment price=price reported by the other mobile body×time loss which occurred when conflict avoidance is carried out by itself), and the payment price for the mobile body of the lower priority is (payment price=0).

This simple example shows that honest reporting is optimal. It is assumed that the cost required for each of the mobile bodies 5b and 5c is quasi-linear. That is to say, it is assumed that cost=arrival time loss×time loss cost+payment price. Here, the time loss cost is a traveling cost which increases due to the time loss per unit time, and the honest reported price means reporting this time loss cost.

As in the above example, it is assumed that the time loss cost of the mobile body 5b is “5” and the reported price of the other mobile body 5c is “3”. At this time, the cost at the time of reporting a price greater than “3” is such that the time loss at arrival is “0”, and cost=0×reported price+payment price (“30”)=30 where the time loss of itself is 10 seconds in the case of carrying out avoidance by itself. Therefore, the mobile body 5b will not gain a profit from changing the reported price from “5”, which is an honest reported price, to a value within a range greater than “3” (“4” for example). On the other hand, if the mobile body 5b lowers the reported price below “3”, the cost=time loss of arrival “10”×time loss cost “5”+payment price “0”=50, and the cost has deteriorated in this case compared to the case of reporting the price honestly.

The previous example shows that the cost would not decrease even if the price is reported lower than the actual price in order to suppress payment. Next, there is described a case where a loss occurs when the price is reported higher. It is assumed that the time loss cost of the mobile body is “5” and the reported price of the other mobile body is “6”. At this time, the cost when reporting honestly=time loss “10”×time loss cost “5”=50, and the cost when reporting a price higher than “6”=time loss “0”+payment price=6×10=60. That is to say, the dishonest reporting has caused deterioration in the cost. The above examples show that reporting the price lower or higher than the honest reported price can cause a loss, depending on the reported price of the other mobile body, and the cost can be suppressed to the lowest level when the price is reported honestly in any case. Therefore, it is expected that the mobile bodies 5 honestly report the time loss cost.

The payment price for conflict avoidance of multiple mobile bodies in the prioritized CA* algorithm is given by the equation (1) below where the current priority position is k-th, the lowest priority position is n-th, and the actual reported priorities of other mobile bodies are used.

$$\begin{matrix} [ Mathematical 1 ] & \\ {\sum }_{k = i + 1}^{n} REPORTED PRICE OF MOBILE BODY OF ORIGINAL PRIORITY POSITION k \times TIME LOSS WHEN PRIORITY POSITION IS CHANGED FROM k - 1 TO k & ( 1 )\end{matrix}$$

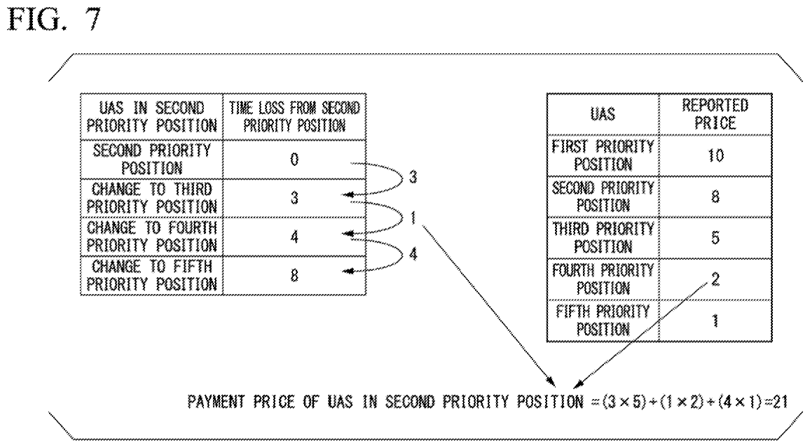

FIG. 7 shows an example in which the payment price of the mobile body in the second priority position is calculated according to the equation (1) above in the case where the mobile body in the second priority position actually causes each of the mobile bodies in the third to fifth priority positions to detour. The table on the left in FIG. 7 shows the time losses from the arrival time of the second priority position when the priorities are provisionally lowered, and the table on the right shows the prices (=priorities) actually reported by each mobile body. In such a situation, when the priority is lowered one by one, the payment price is the sum of the product of the difference between the time loss before and after lowering the priority and the price reported by the mobile body 5 which was originally in the lowered priority position, from the actual priority position of itself to the lowest priority position.

The payment price which encourages honest reporting differs, depending on the path planning algorithm used. A more general method of calculating a payment price is given by the equation below where priorities which can be reported in ascending order are (a₀, a₁, . . . , a_{N}), reported priority is a_{c}, d_{k,k-1} is a function which returns an appropriate value between aₖ and aₖ₋₁ (including aₖ and aₖ₋₁), and the actual reported priorities of other mobile bodies 5 are used.

$$\begin{matrix} [ Mathematical 2 ] & \\ {{\sum }^{c}}_{k = I} {d}_{k , k - 1} \times TIME LOSS WHEN PRIORITY IS CHANGED FROM {a}_{k} TO {a}_{k - 1} & ( 2 )\end{matrix}$$

This equation (2) is described as being a general system of an equation in the prioritized CA* algorithm. In the CA* algorithm, changing the priority within a range in which the priority position does not change does not affect the result of path determination in conflict avoidance. That is to say, in the above equation, time loss is not 0 only at the timing when the priority position changes from aₖ to aₖ₋₁, and this time loss corresponds to time loss when the priority position is changed only by one. The change from aₖ to aₖ₋₁ at the timing when the priority position changes occurs when the priority of the other mobile body is aₖ or aₖ₋₁ (depending on the manner of assigning priority positions when the reported priorities are the same), and by adjusting the function d_{k,k-1}, it can be set that d_{k,k-1}=the priority of the other mobile body when the priority of the other mobile body=aₖ or aₖ₋₁. Therefore, it can be seen that this equation can describe the prioritized CA* algorithm, and that this equation is a general system of payment prices. Honest reporting is achieved by this payment price calculation method, if the path planning algorithm on the basis of priority is to give a path where arrival time is monotonically non-decreasing with respect to its own priority when changing its own priority while the priority of the other mobile bodies are fixed.

Also, as is clear from the conditions for honest reporting, honest reporting is achieved by a payment price given by an equation in which a constant is added to the above equation so that it does not affect the difference between an honestly reported cost and a dishonestly reported cost. Moreover, although it is described as the payment “price”, it is not limited to money, and anything which can be converted into a cost can be changed to “price”. For example, a negative constant may be added to adjust the payment to be negative. A negative payment means that something is given, and coupons or like of equivalent value may be distributed instead of “price”.

After the mobile body has ended traveling (Step 34) and all paths have been determined, the payment price is calculated. Price calculation does not have to be performed immediately after traveling ends. For example, in an air traffic control system, the number of flights at night is small, and therefore, payment price calculation for mobile bodies for the day may be performed during evening hours where the processing is less, and a notification of the payment price may be made on the next day (Step 15). Alternatively, for each path determination made due to conflict avoidance, the payment price may be calculated and notified immediately thereafter. cl EXAMPLE 2

Next, the example 2 will be described. In the example 2, a mobile body corresponds to a person (a vehicle dispatch service user), and a priority determination system and a path determiner correspond to a system which determines vehicle dispatching of a vehicle dispatch service.

The vehicle dispatch service is a service which matches a driver of a vehicle for performing transportation and a user who wants to travel to a destination. Often, in a general vehicle dispatch service, in response to a submission of a user's present location and a user's destination, a nearby registered vehicle is found, and a job for transporting the user is allocated to the driver of the vehicle.

In the vehicle dispatch service system according to the example 2, the user can report not only their present location and their destination (path reporting) but also their own priority. In this vehicle dispatch service system, when a plurality of users are requesting transportation, which vehicles are to be allocated to the users in which order is determined based on priority. Then, depending on the determined vehicle allocation method (path determination in the sense of when the vehicle departs since the user starts traveling after the arrival of the vehicle), an additional charge is determined on the basis of the delay in the arrival time of the low-priority vehicle.

There are considered a plurality of algorithms for determining a vehicle dispatch method. For example, one simple algorithm is to allocate a vehicle which is not already occupied by a user to a nearby highest-priority user. In this algorithm, for example, in a case where one user submits a request and a nearby vehicle A is traveling to pick up that user, if another user later submits a request with a higher priority, the allocation target is changed as the vehicle A is not yet carrying a passenger, and the vehicle A is allocated to the user with the higher-priority.

Moreover, there is considered an algorithm for determining a vehicle dispatch method. In a system which provides a vehicle dispatch service, vehicle dispatching is determined so that the following cost is minimized where α₁ a constant.

Cost=total cost of time taken to dispatch vehicle to user+α₁×total time taken to dispatch vehicle (3)

The cost of time taken to dispatch a vehicle to a user is given by: time taken to dispatch vehicle×time loss cost=time taken to dispatch vehicle×reported priority.

Moreover, α₁ is a weight of the vehicle turnover rate on the vehicle dispatch service side with respect to the cost of the user. The smaller the total amount of time taken to dispatch a vehicle, the sooner the vehicle arrives, and the longer the vehicle will be able to carry the next user through the overall service which the vehicle can provide. Therefore, on the vehicle dispatch service side, it is more profitable to reduce the total amount of time taken to dispatch a vehicle if determination as to which vehicle is dispatched is to be performed based only on the vehicle turnover rate. The equation (3) above is obtained by weighting (α₁) this and adding it to the cost of the user.

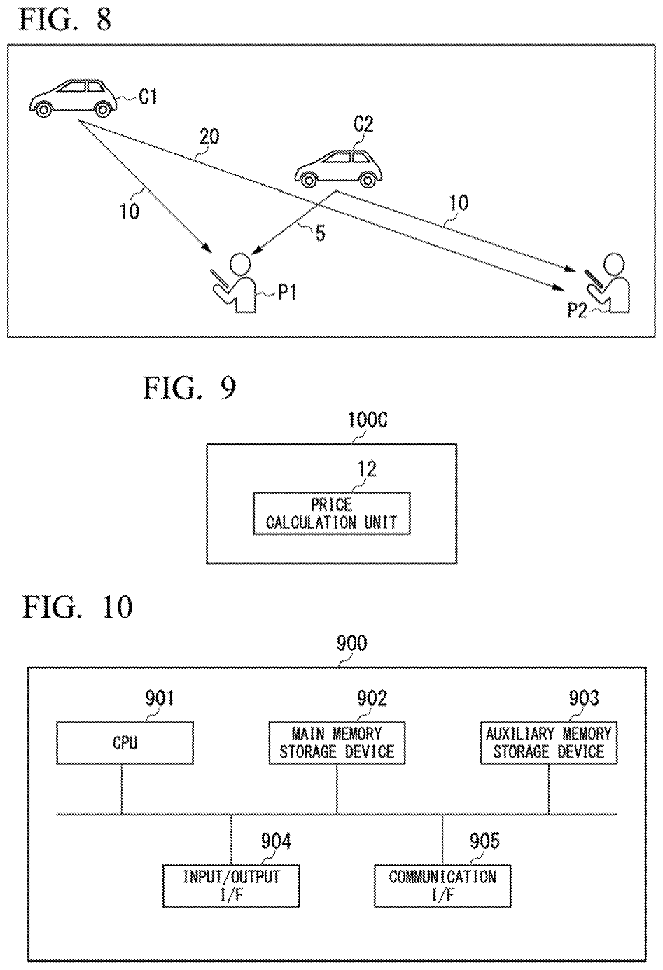

Here, reference is made to FIG. 8. FIG. 8 is a diagram for describing the example 2. FIG. 8 shows two users P1 and P2 and two vehicles C1 and C2. The arrows and numbers in FIG. 8 indicate the amounts of time taken when vehicles are allocated to the users in the directions of the arrows. For example, the amount of time required for a vehicle C1 to travel to the position of a user P1 is “10”, and the amount of time required to travel to the position of a user P2 is “20”. Here, it is assumed that the user P1 reports the priority “3” and the user P2 reports the priority “1”. At this time, there are two types of vehicle dispatching methods, and the total costs thereof are:

(When allocating the vehicle C2 to the user P1 and the vehicle C1 to the user P2) 5×3+20×1+α₁×(5+20)=35+25α₁; and
(When allocating the vehicle C1 to the user P1 and the vehicle C2 to the user P2) 10×3+10×1+α₁×(10+10)=40+20 α₁.

By comparing these two equations, it can be seen that the vehicle dispatching method changes, depending on how significantly the vehicle turnover rate on the vehicle dispatching service side is considered, that is, on the value of α₁. However, when α₁ is determined, the arrival time of the vehicle is monotonically non-decreasing with respect to the priority, and honest reporting can be encouraged by charging the user an appropriate additional fee for this vehicle dispatching method determination algorithm. As described above, the first example embodiment and the second example embodiment can be applied to a situation where it is necessary to take into account not only the cost of the user but also the cost of the path determiner when determining a path.

Moreover, there may be employed a method of, not only charging additional fees, but also discounting the users who reported low priority. In this system, for example, there are three priorities: urgent (priority 10), normal (priority 5), and flexible (priority 0). An additional fee is charged to the user for the urgent, the normal fee is charged for the normal, and the fee is discounted for the flexible.

In this system, fees are set as follows.

Fee=normal charge+payment price on the basis of reported priority−payment price on the basis of reported priority 5 (4)

Here, the payment price on the basis of the reported priority is calculated by the following equation (2) described also in the example 1.

$$\begin{matrix} [ Mathematical 3 ] & \\ {{\sum }^{c}}_{k = I} {d}_{k , k - 1} \times TIME LOSS WHEN PRIORITY IS CHANGED FROM {a}_{k} TO {a}_{k - 1} & ( 2 )\end{matrix}$$

With this fee setting, the normal fee is charged when the priority 5, which is the standard priority, is reported, and an additional fee may possibly be charged in the case of the urgent priority and a discount may possibly made in the case of the flexible priority.

### EXAMPLE 3

The example 3 is an example in which the first example embodiment or the second example embodiment is applied to an intersection signal control system. In the example 3, the signal switching timing at the intersection is appropriately determined, depending on which vehicle is prioritized (path determination in the sense of determining, according to the priority, a path including a restriction such as a temporary stop of a vehicle due to waiting at a stoplight). In the example 3, the mobile body 5 corresponds to a vehicle, and the priority determination system 100 and the path calculation system 150 correspond to a signal control system. Also, payment is assumed be made electronically at each intersection by automatic payment.

In the example 3, the priority is set for each vehicle itself. Moreover, the vehicle has a communication function, and automatically communicates with the signal control system when approaching an intersection. When a vehicle approaches an intersection, the signal control system receives the priority of the vehicle from the vehicle. A signal switching interval is determined according to the equation (5) below.

Switching interval=reference interval−α₂×total priority of vehicles waiting due to stoplight (5)

Here, α₂ is a coefficient representing a weight, and signals are switched so that the larger α₂ is, the shorter the stoplight waiting time for the mobile body having a higher priority.

In the vehicle and the signal control system of the example 3, the priority of a vehicle which is not in a hurry is “0” in many cases, and a vehicle with a high priority is, for example, a vehicle with a delivery task or the like assigned thereto. When a vehicle with a high priority has a delivery task or the like assigned thereto and enters a stoplight waiting state at an intersection, the signal control system at the intersection shortens the signal switching interval to shorten the amount of the stoplight waiting time for the mobile body. When the signal is switched and it is confirmed that the mobile body does not have to enter the stoplight waiting state, the payment procedure commences. An existing system may be used for the automatic payment mechanism itself.

As described above with reference to the examples 1 to 3, the first example embodiment and the second example embodiment of the present invention are capable of performing path determination on the basis of the priority of each mobile body, in a control system for aircraft and UAS, or a control system which uses signals at intersections for vehicles. Furthermore, in a vehicle dispatch service or the like, it can also be applied to an application for determining vehicle dispatching on the basis of priorities.

FIG. 9 is a diagram showing a minimum configuration of the path determination device according to each example embodiment.

As shown in the diagram, a path determination device 100C includes at least a price calculation unit 12. The priority determination systems 100 and 100A described in the example embodiments are examples of the path determination device 100C.

The price calculation unit 12 calculates a cost for a plurality of mobile bodies 5 to travel, based on a time loss indicating a temporal loss that arises when at least some of the mobile bodies 5 among the plurality of mobile bodies 5 take a detour around the other mobile body 5.

When determining conflict-free paths for a plurality of mobile bodies 5 by means of a path planning method on the basis of the priorities of the mobile bodies 5, the price calculation unit 12 determines priorities on the basis of self-reporting of each mobile body 5. Then, the price calculation unit 12 only changes the priority of the mobile body 5 provisionally (from the lowest priority to the self-reported priority) and determines the payment fee according to the self-reporting, on the basis of the arrival time (time loss) of the mobile body for each changed priority.

That is to say, the price calculation unit 12 calculates not only the actual time loss but also the cost on the basis of the time loss when the priority is provisionally changed. Furthermore, when the plurality of mobile bodies 5 are to travel on paths to avoid a conflict or the like, the price calculation unit 12 calculates, for each of the mobile bodies except for the one having the lowest priority (each of all the mobile bodies that cause another mobile body to detour), the cost on the basis of each time loss (including the time loss when the priority is provisionally changed).

FIG. 10 is a diagram showing an example of a hardware configuration of the path determination device in each example embodiment.

A computer 900 includes a CPU (Central Processing Unit) 901, a main memory storage device 902, an auxiliary memory storage device 903, an input/output interface 904, and a communication interface 905. The path determination device 100C described above is implemented in the computer 900. The operation of each processing unit described above is stored in the auxiliary memory storage device 903 in the form of a program. The CPU 901 reads the program from the auxiliary memory storage device 903, loads it on the main memory storage device 902, and executes the processing described above according to the program. Moreover, the CPU 901 secures a memory storage region in the main memory storage device 902 according to the program. Also, the CPU 901 secures a memory storage region in the auxiliary memory storage device 903 according to the program.

Note that in at least one example embodiment, the auxiliary memory storage device 903 is an example of a non-transitory tangible medium. Other examples of non-temporary tangible media include a magnetic disk connected via the input/output interface 904, a magnetic optical disk, a CD-ROM (Compact Disc-Read Only Memory), a DVD-ROM (Digital Versatile Disc-Read Only Memory), and a semiconductor memory. Furthermore, when this program is distributed to the computer 900 via a communication line, the computer 900 which has received the distribution may load the program on the main memory storage device 902 and may execute the above processing. Moreover, this program may be a program for realizing some of the functions described above. Also, the program may be a so-called difference file (a difference program) which realizes the functions described above in combination with another program already stored in the auxiliary memory storage device 903.

Furthermore, it is possible to appropriately replace the constituent elements in the above example embodiments with known constituent elements without departing from the spirit of the present invention. The technical scope of the present invention is not limited to the example embodiments described above, and various modifications may be made without departing from the spirit of the present invention. The table in FIG. 5 is an example of information in which the priority and the reported price for each mobile body are associated with each other. The arrival time loss in “cost=arrival time loss×time loss cost+payment price” in the example 1 and the normal fee in the equation (4) of the example 2 are examples of values which are not dependent on reported priorities. The price calculator 12 is an example of a price calculation means.

The whole or part of the example embodiments disclosed above can be described as, but not limited to, the following supplementary notes.

### (Supplementary Note 1)

A path determination device comprising:

a price calculation means for calculating a cost for a plurality of mobile bodies to travel, based on a time loss, the time loss indicating a temporal loss that arises when at least one of the plurality of mobile bodies takes a detour around another one of the mobile bodies.

### (Supplementary Note 2)

The path determination device according to supplementary note 1, wherein the price calculation means is for calculating the cost for the plurality of mobile bodies to travel, based on a time loss that arises when the at least one of the plurality of mobile bodies travel on a detour path that detours around the other one of the mobile bodies.

### (Supplementary Note 3)

The path determination device according to supplementary note 1 or 2, wherein the price calculation means is for determining the mobile body that detours based on a priority determined for the mobile bodies.

### (Supplementary Note 4)

The path determination device according to any one of supplementary notes 1 to 3, wherein the price calculation means is for calculating a detour path of the mobile body when a priority is changed, and is for calculating a time loss caused by the mobile body traveling on the detour path.

### (Supplementary Note 5)

The path determination device according to any one of supplementary notes 1 to 4, wherein the price calculation means is for setting the calculated cost to be borne by the mobile body which causes another one of the mobile bodies to detour.

### (Supplementary Note 6)

The path determination device according to any one of supplementary notes 1 to 5, wherein the price calculation means is for allocating at least a part of the cost as a profit to the at least one of the mobile bodies which detours around the other one of the mobile bodies.

### (Supplementary Note 7)

The path determination device according to any one of supplementary notes 1 to 5, wherein the price calculation means is for allocating the cost as a profit to a management device which manages travel of the mobile bodies.

### (Supplementary Note 8)

The path determination device according to any one of supplementary notes 1 to 7, wherein the price calculation means is for calculating the cost based on information in which a priority and a reported price for each mobile body are associated with each other.

### (Supplementary Note 9)

The path determination device according to any one of supplementary notes 1 to 8, wherein the price calculation means is for calculating, as the time loss, a difference in arrival times between before and after change when a priority of one mobile body among the plurality of mobile bodies is changed from α to β (β<α) while a priority of another one of the mobile bodies is fixed.

### (Supplementary Note 10)

The path determination device according to supplementary note 9, wherein the price calculation means is for calculating a cost of the mobile body based on a product of the calculated time loss and a predetermined numerical value that is one from the α to the β.

### (Supplementary Note 11)

The path determination device according to supplementary note 10, wherein the price calculation means is for calculating the product where α or β is used as the predetermined numerical value when N+1 priorities aₙ (n=0 to N) which can be reported are expressed as a₀ to a_{N} in ascending order of priority and α=aₖ and β=aₖ₋₁ are given for a predetermined natural number k among 0 to N.

### (Supplementary Note 12)

The path determination device according to supplementary note 11, wherein the price calculation means is for calculating a cost of the mobile body which has reported a priority a_{c} by summing products calculated for all natural numbers k from 1 to c.

### (Supplementary Note 13)

The path determination device according to claim 12, wherein the price calculation means is for calculating the cost of the mobile body by further adding a value not dependent on the reported priority a_{c} to the cost calculated by summing.

### (Supplementary Note 14)

The path determination device according to supplementary note 1, wherein the price calculation means is for calculating the cost for the plurality of mobile bodies to travel, based on an amount of time taken by the at least one of the plurality of mobile bodies to stand-by for detouring around the other one of the mobile bodies.

### (Supplementary Note 15)

A path determination method executed by a computer, the method comprising:

calculating a cost for a plurality of mobile bodies to travel, based on a time loss, the time loss indicating a temporal loss that arises when at least one of the plurality of mobile bodies takes a detour around another one of the mobile bodies; and

determining paths of the plurality of mobile bodies, based on the calculated cost.

### (Supplementary Note 16)

A storage medium that stores a program which causes a computer to function as:

a means for calculating a cost for a plurality of mobile bodies to travel, based on a time loss, the time loss indicating a temporal loss that arises when at least one of the plurality of mobile bodies takes a detour around another one of the mobile bodies.

### INDUSTRIAL APPLICABILITY

According to the path determination device, the path determination method, and the storage medium mentioned above, it is possible to calculate an appropriate cost for a mobile BODY TO TRAVEL.

### REFERENCE SYMBOLS

1, 1A Path determination system

100, 100A Priority determination system

100C Path determination device

150, 150A Path calculation system

10 Priority receiving unit

11 Priority storage unit

12 Price calculation unit

13 Path acquisition unit

13A Path plan acquisition unit

14 Price notification unit

15 Path determination unit

16 Path planning unit

900 Computer

901 CPU

902 Main storage device

903 Auxiliary storage device

904 Input/output interface

905 Communication interface

1. A path determination device comprising:
a memory configured to store instructions; and
a processor configured to execute the instructions to: calculate a cost for a plurality of mobile bodies to travel, based on a time loss, the time loss indicating a temporal loss that arises when at least one of the plurality of mobile bodies takes a detour around another one of the mobile bodies.

2. The path determination device according to claim 1, wherein calculating the cost comprises calculating the cost for the plurality of mobile bodies to travel, based on a time loss that arises when the at least one of the plurality of mobile bodies travel on a detour path that detours around the other one of the mobile bodies.

3. The path determination device according to claim 1, wherein the processor is configured to execute the instructions to: determine the mobile body that detours based on a priority determined for the mobile bodies.

4. The path determination device according to claim 1, wherein the processor is configured to execute the instructions to: calculate a detour path of the mobile body when a priority is changed, and calculate a time loss caused by the mobile body traveling on the detour path.

5. The path determination device according to claim 1, wherein the processor is configured to execute the instructions to: set the calculated cost to be borne by the mobile body which causes another one of the mobile bodies to detour.

6. The path determination device according to claim 1, wherein the processor is configured to execute the instructions to: allocate at least a part of the cost as a profit to the at least one of the mobile bodies which detours around the other one of the mobile bodies.

7. The path determination device according to claim 1, wherein the processor is configured to execute the instructions to: allocate the cost as a profit to a management device which manages travel of the mobile bodies.

8. The path determination device according to claim 1, wherein calculating the cost comprises calculating the cost based on information in which a priority and a reported price for each mobile body are associated with each other.

9. The path determination device according to claim 1, wherein the processor is configured to execute the instructions to: calculate as the time loss, a difference in arrival times between before and after change when a priority of one mobile body among the plurality of mobile bodies is changed from α to β (β<α) while a priority of another one of the mobile bodies is fixed.

10. The path determination device according to claim 9, wherein calculating the cost comprising calculating a cost of the mobile body based on a product of the calculated time loss and a predetermined numerical value that is one from the α to the β.

11. The path determination device according to claim 10, wherein the processor is configured to execute the instructions to: calculate the product where α or β is used as the predetermined numerical value when N+1 priorities aₙ (n=0 to N) which can be reported are expressed as a₀ to a_{N} in ascending order of priority and α=aₖ and β=aₖ₋₁ are given for a predetermined natural number k among 0 to N.

12. The path determination device according to claim 11, wherein calculating the cost of the mobile body comprises: calculating a cost of the mobile body which has reported a priority a_{c} by summing products calculated for all natural numbers k from 1 to c.

13. The path determination device according to claim 12, wherein calculating the cost of the mobile body comprises: calculating the cost of the mobile body by further adding a value not dependent on the reported priority a_{c} to the cost calculated by summing.

14. The path determination device according to claim 1, wherein calculating the cost comprises calculating the cost for the plurality of mobile bodies to travel, based on an amount of time taken by the at least one of the plurality of mobile bodies to stand-by for detouring around the other one of the mobile bodies.

15. A path determination method executed by a computer, the method comprising:
calculating a cost for a plurality of mobile bodies to travel, based on a time loss, the time loss indicating a temporal loss that arises when at least one of the plurality of mobile bodies takes a detour around another one of the mobile bodies; and
determining paths of the plurality of mobile bodies, based on the calculated cost.

16. A non-transitory computer-readable storage medium that stores a program which causes a computer to execute:
calculating a cost for a plurality of mobile bodies to travel, based on a time loss, the time loss indicating a temporal loss that arises when at least one of the plurality of mobile bodies takes a detour around another one of the mobile bodies.
